(19) United States
(12) Patent Application Publication
(10) Pub. No.: US 2011/0036593 A1
(43) Pub. Date: Feb. 17, 2011

(54) FORMATION OF FLOW CONDUITS UNDER PRESSURE

(76) Inventor: Charles Deible, Katy, TX (US)

Correspondence Address: SCHLUMBERGER OILFIELD SERVICES, 200 GILLINGHAM LANE, MD 200-9, SUGAR LAND, TX, 77478, US

(21) Appl. No.: 12/743,858

(22) PCT Filed: Nov. 19, 2008
(86) PCT No.: PCT/EP08/09804

§ 371 Date: Oct. 27, 2010

(30) Foreign Application Priority Data
Nov. 22, 2007 (GB) 0722910.7

(51) Int. Cl. F16L 11/16

(52) U.S. Cl. 166/380

(57) ABSTRACT

A method for providing a flow conduit in a pressurised well is provided. The method comprising the steps of: providing a supply of material for forming the conduit outside the well; introducing the material into the well through a pressure control system; and forming the material into a tube in the well to define the flow conduit.

### CROSS-REFERENCE TO RELATED APPLICATIONS

The present application is based on and claims priority to GB Application No. 0722910.7, filed 22 Nov. 2007; and International Patent Application No. PCT/EP2008/009804, filed 19 Nov. 2008. The entire contents of each are herein incorporated by reference.

### TECHNICAL FIELD

This invention relates to techniques for forming tubular flow conduits under pressure. In particular it relates to the formation of such conduits in wells such as oil or gas wells without the necessity to kill the well.

### BACKGROUND ART

At different stages in the life of a producing oil or gas well, it can be necessary to perform interventions for a number of reasons. These can include repairs or modifications in the producing tubing assembly such as cleaning of the well bore; pumping of stimulation or cleaning fluids; milling restrictions; operation or repair of valves; modification of the producing zones by perforating; or drilling new reservoir zones. Other reasons are to enhance production, so that more zones of the reservoir can be put to production by perforating new zones or drilling lateral drain holes.

These interventions can be performed by killing the well (filling it with a heavy fluid to balance the formation pressure and prevent production of fluids). However, in many cases, it is desirable to perform such interventions without killing the well and with pressure at the well head. This is typically to avoid damage to producing zones by invasion of killing fluids. This implies keeping the well under-balanced or near-balanced with produced fluids, gas or light fluids. This in turn means that pressure will be continually present at the well head during the deployment, operation and retrieval of the downhole tools, umbilical and wireline cable used to perform the intervention. A major concern in these types of interventions is to safely contain the well head pressure while deploying the intervention tools.

Flow conduits used during these interventions need to be designed according to the requirements of downhole operation; the need to present a small cross section; resistance to wear, temperature, pressure; and they must be able to mate to the downhole equipment. Additional requirements, generated by the deployment operation, involve resistance to well pressure when exiting at surface; fixtures to allow deployment under pressure at surface such as dynamic pressure seals that allow movement in and out of the well; injectors to compensate for the forces generated by the well pressure; and other fixtures to assemble equipment at surface. These design requirements are difficult to satisfy because the large safety coefficient (margin) required for the operation of surface equipment under pressure is often contradictory to the need for a small cross section required for downhole operation and ease of deployment at surface under pressure.

One existing means to perform these types of interventions is coil tubing, but this involves the use of very large and expensive surface equipment such as injectors and strippers. Also the safety coefficient for coil tubing is low and it is not widely accepted to circulate well fluids to surface with coil tubing. Very high stresses in coil tubing during deployment can lead to fatigue and possible failures not compatible with safe operation under pressure at surface. Another existing means to perform these types of interventions is pipe snubbing, but this system has several limitations in terms of time performance and safety.

It is the purpose of this invention to provide techniques that can be used to allow safe deployment and retrieval of a tool string, cable and flow conduit with formation induced well pressure at the well head. The basis of the invention is the construction of the conduit in the well.

There have been a number of proposals to construct equipment downhole or to provide designs that can be applied to downhole tools and equipment. These include:

U.S. Pat. No. 6,679,334 which discloses a system for completing wells by conveying a metal strip into the well and forming a tubular down hole;
U.S. Pat. No. 6,250,385 which discloses an expandable liner for completing a well in which complementary touching profiles lock together upon expansion;
U.S. Pat. No. 4,924,684 which discloses a device for forming and slitting spiral lock seam tubing of diameter one inch or less;
U.S. Pat. No. 5,911,457 which discloses a device for producing a double walled spiral tubing for producing air ducts;
WO 2005/005753 which discloses a lock seam profile that makes a water tight joint;
U.S. Pat. No. 5,737,832 which discloses a double walled spiral tubing; and
U.S. Pat. No. 6,561,228 which discloses spiral tubing with a string or rubber gasket inserted to prevent the lock seam from slipping and altering the diameter of the final tubing.

The objective of the invention is to facilitate deployment of a cable and flow conduit into a live well under surface pressure in a safe and efficient manner, while imposing minimal additional requirements on the downhole equipment. This invention provides a flow conduit such that a downhole tool can pump well fluids through the flow conduit and dump or expel the well fluids at any point between the downhole tool and the uphole end of the flow conduit.

### DISCLOSURE OF THE INVENTION

A first aspect of this invention provides a method of providing a flow conduit in a pressurized well, comprising:
providing a supply of material for forming the conduit outside the well;
introducing the material into the well through a pressure control system; and
forming the material into a tube in the well to define the flow conduit.

The material may be provided in flat or as a part-formed tube. The edges of the material can then be joined together to form the tube. In one embodiment, the material is provided in the form of an elongate strip, the edges of which are joined to form a substantially linear axial seam along the tube. In this case, the edges of the strip can be configured to provide inter-engageable formations which are joined together to form the seam. In another embodiment, the strip is wound in a spiral form to define the tube, adjacent edges of the strip being joined to form a spiral seam.

The pressure control system preferably includes a dynamic seal that allows the material to be fed progressively into the well while it is maintained at pressure.

The pressure control system may alternatively include a pressure vessel that is at substantially the same pressure as the well and that allows the material to be fed progressively from the pressure vessel into the well.

It is particularly preferred to form the tube around a cable in the well. In one embodiment, the cable is introduced into the well prior to introduction of the tube material, and the tube is formed around the cable already in the well. In another embodiment, the cable is introduced into the well through the pressure control system together with the tube material.

The method may also comprise deploying a tube forming machine into the well prior to introduction of the material. The cable, when present, is preferably threaded through the tube forming machine.

A flexible liner may optionally be provided inside the formed tube. One preferred example is a lay-flat hose that can be inflated once the tube is formed.

A connector may also be deployed into the well for connection of downhole equipment to the conduit after formation of the tube. The conduit can also be connected to other equipment at the surface to admit fluids to and/or remove fluids from the conduit. This can also be used to connect to the cable, when present, to support at least part of the weight of the conduit.

One particularly preferred embodiment comprises connecting the conduit to a downhole drilling machine which can then be used to drill a borehole, the conduit being used for the flow of drilling fluid to or from the drilling machine.

The process of removing the conduit from the well can comprise deconstructing the tube before it is withdrawn from the pressurized well. This can be achieved by opening a seam or cutting the formed tube.

A system for performing these methods comprises:
a supply of material for forming the conduit outside the well;
means for introducing the material into the well through a pressure control system; and
means for forming the material into a tube in the well to define the flow conduit.

Other aspects of the invention will be apparent from the description below.

### BRIEF DESCRIPTION OF THE DRAWINGS

FIG. 1 shows a schematic diagram of a deployment system for use in an embodiment of the invention.

### MODE(S) FOR CARRYING OUT THE INVENTION

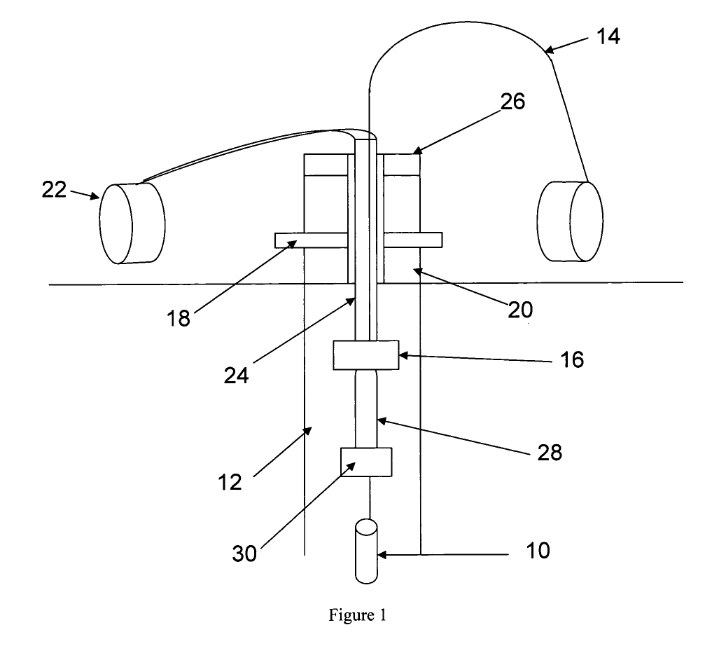

The invention will be described in relation to FIG. 1. Certain known elements of the wellhead deployment system have been omitted for clarity. The embodiment of the invention described allows deployment of tool strings that require the presence of a flow conduit and a wireline cable. An example of such a tool string is a wireline drilling apparatus bottom hole assembly (BHA) for drilling lateral boreholes from the main well.

For long tool strings 10 (shown in part in FIG. 1) the tool must first be deployed into the well 12 on a wireline cable 14 using standard techniques, and located in a deployment stack (not shown). The deployment stack serves to isolate well pressure while allowing dry access to the electrical interface connections at the top of the tool 10. After the tool is safely in the deployment stack and the seal tested the pressure is bled from the pressure containment vessel (PCV, not shown). The wireline cable 14 is then removed to allow a tubing forming head 16 to be inserted.

At this stage, any fluid conduit through the tool string fluid is safely below the deployment rams 18 in the wellhead equipment 20. This eliminates the need for a valve in the toolstring/BHA to isolate well pressure.

Next the tube forming machine 16 is rigged up. The cable 14 is threaded through the tube forming machine 16. Sufficient cable is pulled through the machine 16 to allow access for the following steps.

A supply of material for forming a conduit is located close to the wellhead on a reel 22. The material is present on the reel 22 as a band or strip of flat metal 24. It will be understood that the band or strip 24 may be of other material such as, for example, plastic, glass fiber composite, carbon fiber composite, or metal composite. The band 24 is inserted through the dynamic seal 26 in the wellhead equipment 20 and into the tube forming machine 16 and the tube forming process started. After a length of good tube 28 has been formed around the cable 14, a hydraulic latch sub 30 providing a connection for the toolstring/BHA 10 is slid up over the cable 14 and joined to the end of formed tubing 28.

The cable 14 is connected to the toolstring/BHA 10 and any extra cable slack pulled from the system.

After function testing the toolstring/BHA 10 to ensure it is in working order the PCV can be reconnected, a seal obtained on the cable 14 and band 24 and the PCV pressurized to match that of the well. The BHA weight is thus supported up by the cable 14 and the deployment stack can be opened.

The BHA 10 and cable 14 are run into hole to a depth that is equivalent to the length of flow conduit required and stopped. Once the desired depth is achieved the tube forming machine 16 is started and the flow conduit 28 formed around the cable 14, the band 24 being fed into the well as the tube 28 is formed. As the flow conduit 28 is formed the tube and latching sub 30 are lowered in the well 12, the formed tube supporting its own weight plus that of the latching sub 30.

When the tube 28 is near the BHA 10 the tube forming machine 16 is stopped. The BHA 10 is moved in the up hole direction using the cable winch so that it can latch hydraulically to the latching sub 30.

In another embodiment, the BHA 10 can be latched to the latching sub 30 immediately after opening the deployment stack. The tube 28 is then formed as the cable 14 is lowered in the well 12. This requires synchronization in the tube forming machine 16 such that its speed matches that of the cable running speed. Excess weight could damage the tubing and too slow of a speed could cause the tubing to buckle. This approach may have the advantages that some time is saved and the cable can be used to support some of the weight of the formed tube.

Once the latching sub 30 has been successfully connected to the BHA 10, it is pressure tested to ensure the integrity of the new tube. The tubing in the PCV is then mechanically coupled to the cable 14 to ensure that the formed metal tube 28 maintains a tensile loading profile and avoids excessive compressive forces when the BHA is in operation. The mechanical coupling between the cable and the formed metal tube also forms an exit port that will allow for well fluids to exit flow conduit 28 without plugging.

After successful latching of the tubing to the cable, the BHA and cable/flow conduit system can be moved to any point in the well and back using the wireline cable winch.

To retrieve the BHA the cable is pulled back into the PCV and the cable to metal tube coupling is disengaged. Once this system is disengaged the formed metal tube can be deconstructed by opening the lock seam, or alternatively it can be cut longitudinally and wound on a drum for disposal.

The formed tube can be of several varieties. A linear lock seam can be formed by inserting a flat metal strip, or a partially preformed strip, inside the PCV through a dynamic seal. Once inside the PCV the strip is completely roll formed into the shape of a tube and the edges joined and sealed using a lock seam longitudinally along the tube.

A spiral lock seam does not require roll forming of the flat strip. Rather the tube is wrapped in a spiral configuration to form a tube and the edges joined with a lock seam that follows the spiral strip. Spiral tubing requires that the formed tube be rotated, which may mean that the tool can only be connected to the tubing after the entire length of tube has been formed.

The lock seam has the advantage that it can be easily formed from a flat metal strip. This allows the lock seam edge profiles to be completely formed and joined inside the PCV, thus allowing for only a flat metal strip, or very simple shape, to pass through the dynamic seal.

In another configuration, the metal strip has preformed edges that lock together. However, a preformed lock profile may be more difficult to dynamically seal than a flat metal strip. Alternatively the strip can be placed inside a pressure vessel, eliminating the need for the dynamic seal.

The specific application may require the formed tubing to hold a substantial internal pressure. Ideally the lock seam can be formed and crimped in such a way that it can withstand the internal pressure without the need for another process or seal. Small leakages may be tolerable in the tubing as the well fluids will often contain fine particles of sand, which can be a very effective plug. The torturous path of the lock seam may therefore permit fluid to pass, but not sand, which will result in the desired effect of transporting the cuttings out of the lateral.

To seal the lock seam an elastomer may be inserted into the seam before crimping. This is similar to what is described in U.S. Pat. No. 6,561,228. The pressure from the crimping rollers will thus mechanically lock the seam to form the tube and compress the elastomer to seal it against leakage.

In further embodiments of the invention the tube may be formed from a band or strip 24 which is of another type of material such as, for example, plastic, glass fiber composite, carbon fiber composite, or metal composite. The edges of these tubes in the further embodiments may be joined and sealed by mechanical methods such as a lock seam, a zipper or slide fastening device, or the interlocking of preformed edges on the tube. The edges of these tubes in the further embodiments may also be joined by methods involving the use of welding or adhesives.

In another embodiment of the invention the strip or band of material is inserted through a pressure vessel that is at substantially the same pressure as the well. This allows the material to be fed progressively from the pressure vessel into the well without the use of a dynamic seal.

Application WO 2005/005753 shows a water tank with a liner. It may be possible to line a tubular in the same manner to create a pressure tight seal.

A thin lay-flat polymer hose can be inserted inside the tubing as it is formed to provide yet another means to give the formed metal tube pressure integrity. After the tube is completely formed the hose can be inflated with pressure from surface or from the BHA. The formed metal tube will protect the thin lay-flat hose in open hole and in the window opening when passing from a main borehole to a lateral, and provide structural integrity so that the desired burst pressure rating can be maintained.

Inserting a lining may have other advantages as well. While drilling, the flow conduit will be full of well fluid, which may be transporting drilling cuttings. If for some reason the BHA stops pumping while drilling, the cuttings will tend to settle inside the conduit. Upon resumption of pumping the cuttings must be mobilized such that they flow through the conduit and exit at the appropriate point. If a large volume of cuttings settle in one area, the base of the flow conduit for example, mobilizing them may be very difficult. As a result of a failure to mobilize accumulated cuttings the flow conduit may have the undesirable effect of plugging thus resulting in the BHA and conduit having to be retrieved from the well to effect repairs. A liner may be constructed with ridges such that when the BHA stops pumping the ridges serve to catch the cuttings as they fall to the low side of the conduit in the non-vertical sections of the well. In this manner the cuttings will be evenly distributed along the length of the umbilical and there will be no excessive accumulation of cuttings at any single point.

1. A method for providing a flow conduit in a pressurized well, comprising the steps of:
providing a supply of material for forming the conduit outside the well;
introducing the material into the well through a pressure control system; and
forming the material into a tube in the well to define the flow conduit.

2. The method as claimed in claim 1, wherein the material is provided as a flat strip or as a part-formed tube.

3. The method as claimed in claim 2, wherein the edges of the material are joined together to form the tube.

4. The method as claimed in claim 3, wherein the material is provided in the form of an elongate strip, the edges of which are joined to form a substantially linear axial seam along the tube.

5. The method as claimed in claim 4, wherein the edges of the strip are configured to provide inter-engageable formations which are joined together to form the seam.

6. The method as claimed in claim 4, wherein the strip is wound in a spiral form to define the tube, adjacent edges of the strip being joined to form a spiral seam.

7. The method as claimed in claim 1, wherein the pressure control system includes a dynamic seal that allows the material to be fed progressively into the well while it is maintained at pressure.

8. The method as claimed in claim 1, wherein the pressure control system includes a pressure vessel that is at substantially the same pressure as the well and that allows the material to be fed progressively from the pressure vessel into the well.

9. The method as claimed in claim 1, comprising forming the tube around a cable in the well.

10. The method as claimed in claim 9, wherein the cable is introduced into the well prior to introduction of the tube material, and the tube is formed around the cable in the well.

11. The method as claimed in claim 9, wherein the cable is introduced into the well through the pressure control system together with the tube material.

12. The method as claimed in claim 1, comprising deploying a tube forming machine into the well prior to introduction of the material.

13. The method as claimed in claim 12, wherein a cable is threaded through the tube forming machine so that the tube can be formed around the cable.

14. The method as claimed in claim 1, wherein a flexible liner is provided inside the formed tube.

15. The method as claimed in claim 14, wherein the liner comprises a lay-flat hose that can be inflated once the tube is formed.

16. The method as claimed in claim 1, wherein a connector is deployed into the well for connection of downhole equipment to the conduit after formation of the tube.

17. The method as claimed in claim 1, wherein the conduit is connected to other equipment at the surface to admit fluids to and/or remove fluids from the conduit.

18. The method as claimed in claim 17, wherein the connector is used to connect to a cable to support at least part of the weight of the conduit.

19. The method as claimed in claim 1, further comprising connecting the conduit to a downhole drilling machine which can be used to drill a borehole, the conduit being used for the flow of drilling fluid to or from the drilling machine.

20. The method as claimed in claim 1, comprising removing the conduit from the well by deconstructing the tube before it is withdrawn from the pressurized well.

21. The method as claimed in claim 20, wherein deconstruction comprises opening a seam or cutting the formed tube.

22. A system for performing the method as claimed in claim 1, comprising:
a supply of material for forming the conduit outside the well;
means for introducing the material into the well through a pressure control system; and
means for forming the material into a tube in the well to define the flow conduit.
